(19) United States
(12) Patent Application Publication
(10) Pub. No.: US 2006/0112309 A1
(43) Pub. Date: May 25, 2006

(54) Method and apparatus to backup data in a hard disk drive

(76) Inventors: Andrei Khurshudov, San Jose, CA (US); Debasis Baral, San Jose, CA (US)

Correspondence Address: GSS LAW GROUP, Suite 317, 3900 Newpark Mall Road, Newark, CA, 94560, US

(21) Appl. No.: 10/993,478

(22) Filed: Nov. 18, 2004

(51) Int. Cl. G06F 11/00

(52) U.S. Cl. 714/13

(57) ABSTRACT

Making backups of active data stored in hard disk drive, by copying one or more disk surfaces within the hard disk drive. The hard disk drives implement the method. The hard disk drive may include more than two disk surfaces. Copying a second disk surface to a first disk surface may restore the first disk surface from the backup found on the second disk surface. The invention includes computer systems, which include at least one of these hard disk drives. The invention also includes removable storage systems, which include at least one of the hard disk drives.

### TECHNICAL FIELD

The invention relates to the operation of hard disk drives. More particularly, the invention relates to copying at least one disk surface to backup data in active use within a hard disk drive.

### BACKGROUND OF THE INVENTION

Prior art hard disk drive users have problems, which are not easily solved. With large disk memories, and the increasing use of hard disk drives to retain personal, technical, and business records for long periods of time, it is increasingly difficult and expensive to backup the data of a hard disk drive. Many organizations and businesses have information technology groups, typically providing data backup services. Such services allow for reliable off-line backup of the hard disk drive data of the computer users of the organization or business. If something goes wrong, these groups can use the off-line backups to restore the hard disk drive data for them. However, many computer users do not belong to such organizations, nor are employed by such businesses. They are faced with having to perform these functions themselves. Backing up a forty gigabyte hard disk drive for off-line storage can be challenging.

What is needed is a way to backup the active data of a hard disk drive that neither ties up the computer or the computer user. What is further needed is a way to provide offline backups without the clutter, confusion, or expense of external backup media. A new method of data backup for large disk drives is needed which can be done with a minimum of equipment and without specialists.

### SUMMARY OF THE INVENTION

The invention supports making backups of the active data stored in a hard disk drive by copying one or more disk surfaces within the hard disk drive. This keeps a complete snapshot of the disk surface(s) used in active data storage without external memory devices. The invention includes the hard disk drives implementing the method. The hard disk drive may include more than two disk surfaces. Keeping more than one snapshot preferably allows successive backups to reside in the hard disk drive. Backup of the first disk surface to the second disk surface may be augmented by copying the second disk surface to the first disk surface to restore the first disk surface from a backup found on the second disk surface. The invention includes making the hard disk drive, and the product of such a manufacturing process.

The invention includes computer systems including these hard disk drives. The invention also includes removable storage systems which contain at least one hard disk drive in accord with the invention, and which may communicate via a wireline and/or wireless physical transport with a computer system.

### BRIEF DESCRIPTION OF THE DRAWINGS

FIG. 1A shows a simplified schematic of a hard disk drive implementing all of the invention's methods, which may be preferred;

FIG. 1B shows the hard disk drive of FIG. 1A including more than a first disk, providing more than the first disk surface and the second disk surface;

FIG. 2A shows a detail flowchart of the program system of FIG. 1A;

FIG. 2B shows a detail flowchart of FIG. 2A;

FIG. 3A shows a detail flowchart of the backup method of FIG. 2A;

FIG. 3B shows a track on one of the disk surfaces of FIGS. 1A and 1B;

FIG. 4B shows an alternative schematic of the hard disk drive of FIGS. 1A and 1B;

FIGS. 5A to 5H show computer systems including the invention's hard disk drive;

FIG. 5I shows the computer system of FIG. 5A further including a disk-setting cable coupled to the external cable socket of FIG. 4B; and

FIG. 5J shows the invention also including a removable storage system.

### DETAILED DESCRIPTION

The invention supports making backups of the active data stored in a hard disk drive by copying one or more disk surfaces within the hard disk drive. This keeps a complete snapshot of the disk surface(s) used in active data storage without external memory devices. The invention includes the hard disk drives implementing the method and may include more than two disk surfaces. Keeping more than one snapshot preferably allows successive backups to reside in the hard disk drive. Backup of the first disk surface to the second disk surface may be augmented by copying the second disk surface to the first disk surface to restore the first disk surface from a backup found on the second disk surface.

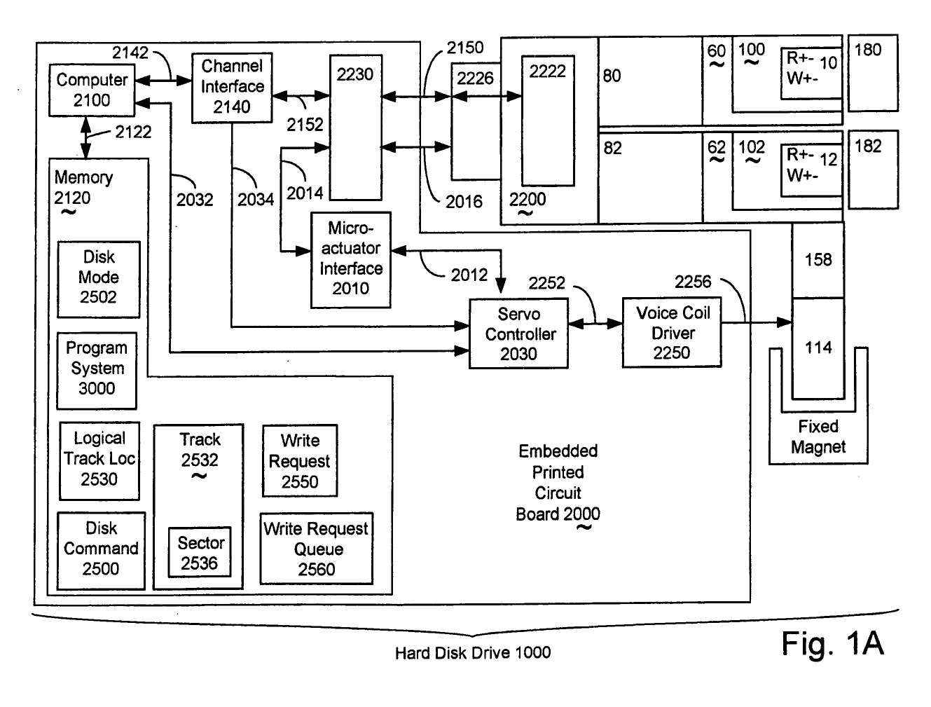

This invention's method may be implemented in a hard disk drive 1000 as shown in FIG. 1A. This hard disk drive includes an embedded printed circuit board 2000. The components of a voice coil actuator 118, and possibly a micro-actuator assembly 200, position the read-write head 10 over a first disk surface 180. The read-write head 10 accesses the first disk surface 180 to read and write data. The embedded printed circuit board 2000 is shown preferably including at least one computer 2100, at least one channel interface 2140, at least one micro-actuator interface 2010, a servo-controller 2030 and a voice coil driver 2250. Overall operation of the hard disk drive 1000 is typically directed by the program system 3000. The program system 3000 includes program steps residing in a memory 2120. The memory 2120 is accessibly coupled 2122 to the computer 2100.

Some of the following figures show flowcharts of at least one method of the invention, which may include arrows with reference numbers. These arrows signify a flow of control, and sometimes data, supporting various implementations of the method. These include at least one the following: a program operation, or program thread, executing upon a computer; an inferential link in an inferential engine; a state transition in a finite state machine; and/or a dominant learned response within a neural network.

The operation of starting a flowchart refers to at least one of the following. Entering a subroutine or a macro instruction sequence in a computer. Entering into a deeper node of an inferential graph. Directing a state transition in a finite state machine, possibly while pushing a return state. And triggering a collection of neurons in a neural network. The operation of starting a flowchart is denoted by an oval with the word “Start” in it.

The operation of termination in a flowchart refers to at least one or more of the following. The completion of those operations, which may result in a subroutine return, traversal of a higher node in an inferential graph, popping of a previously stored state in a finite state machine, return to dormancy of the firing neurons of the neural network. The operation of terminating a flowchart is denoted by an oval with the word “Exit” in it.

A computer as used herein will include, but is not limited to, an instruction processor. The instruction processor includes at least one instruction processing element and at least one data processing element. Each data processing element is controlled by at least one instruction processing element.

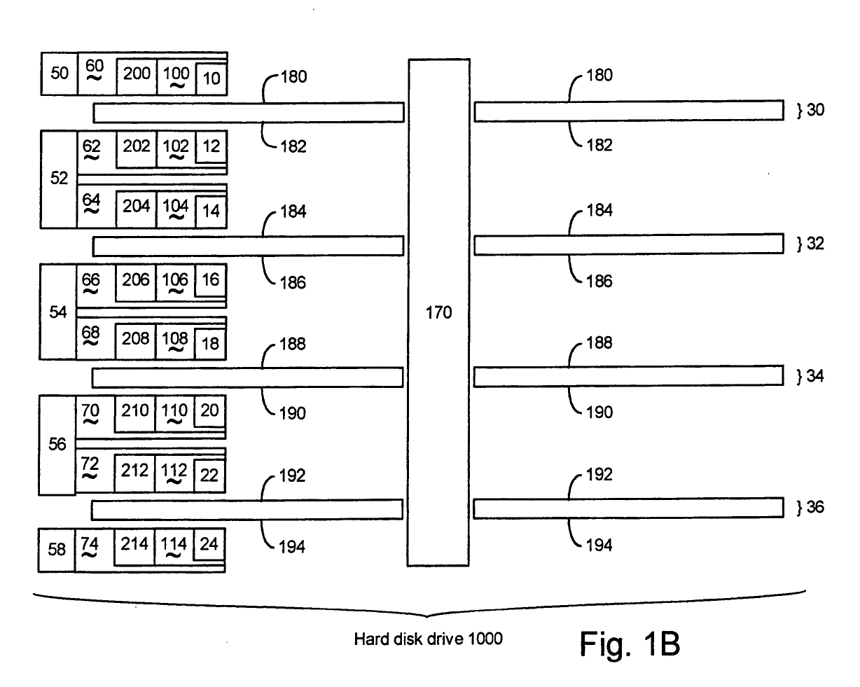

Performing backup of the first disk surface 180 to the second disk surface 182 when the disk-command 2500 is the backup-purpose 2512 is shown in FIG. 2A as a detail of the program system 3000 of FIG. 1A. Operation 3112 determines when the disk-command 2500 is the backup-purpose 2512, and when the determination 3114 is Yes, operation 3116 performs copying of the first disk surface 180 to the second disk surface 182.

In certain aspects of the invention, a similar operation to that found in FIG. 2A, may support copying the second disk surface 182 to the first disk surface 180 when the disk-command 2500 is a restore-purpose 2519. This would act to restore the backup stored on the second disk surface 182 to the first disk surface 180.

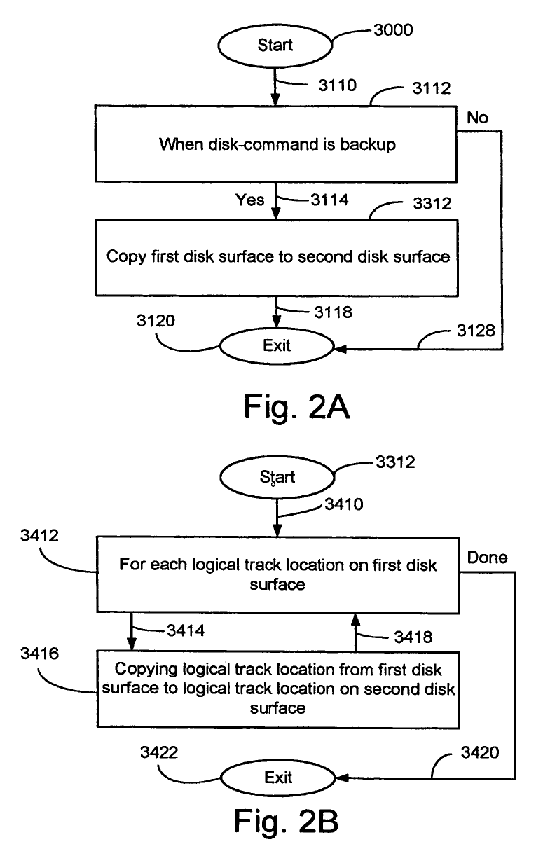

Performing the backup of the first disk surface 180 to the second disk surface 182 is shown in FIG. 2B as a detail of the backup method 3022 of FIG. 2A. Operation 3412 determines if more iterations of operation 3416 are required for each logical track location 2530 on the first disk surface 180, and when the iterations are done, arrow 3420 directs the flow of execution to operation 3422, terminating the operations of this flowchart. Operation 3416 is the body of the loop, copying the track 1800, shown in FIG. 3B, at the logical track location 2530 from the first disk surface 180 to the logical track location 2530 on the second disk surface 182.

The hard disk drive 1000 containing the first disk surface 180 and the second disk surface 182 and the configurations preferably supported by the disk-mode 2502 of FIG. 1A is shown in Table 1. Table 2 shows the use over time of this hard disk drive when the disk-mode is backup-1, or one internal backup.

TABLE 1
Configurations for a dual disk surface hard disk
drive 1000 in accord with the invention.

| Disk-mode 2502 | First disk surface 180 | Second disk surface 182 |
|---|---|---|
| All-active | Used for active data storage | Used for active data |
| | | storage |
| Backup-1 | Used for active data storage | Used for backup data |
| | | storage |

TABLE 2
Use of the hard disk drive 1000 of Table One
configured by disk-mode 2502 set to backup-1.

| | Time | | |
|---|---|---|---|
| | Before | | After restoring |
| | backup | After backup | from backup |
| First disk surface | Active | Active data | Active data at |
| 180 for active use | data | | time of backup |
| Second disk surface | In backup | Inactive data = active | Inactive |
| 182 for backup | | data at time of backup | data = active |
| | | | data at time of |
| | | | backup |

Two configurations of a hard disk drive 1000 containing four disk surfaces preferably supported by a disk-mode 2502 of FIG. 1A are shown in Tables 3 and 4. Table 5 shows use over time of this hard disk drive when the disk-mode dictates backup-1, or one internal backup, as shown in Table 3. Table 6 shows use over time of this hard disk drive when the disk-mode dictates backup-2, or three internal backups.

TABLE 3
One embodiment of configurations of a hard disk drive 1000 containing
four disk surfaces supported by the disk-mode 2502.

| Disk-mode | First disk | Second disk | Third disk | Fourth disk |
|---|---|---|---|---|
| 2502 | surface 180 | surface 182 | surface 184 | surface 186 |
| All-active | Active data | Active data | Active data | Active data |
| | store | store | store | store |
| Backup-1 | Active data | In backup | Active data | In backup |
| | store | | store | |
| Backup-2 | Active data | In backup | In backup | In backup |
| | store | | | |

TABLE 4
An alternative embodiment of the hard disk drive 1000 containing
four disk surfaces supported by the disk-mode 2502.

| Disk-mode | First disk | Second disk | Third disk | Fourth disk |
|---|---|---|---|---|
| 2502 | surface 180 | surface 182 | surface 184 | surface 186 |
| All-active | Active data | Active data | Active data | Active data |
| | store | store | store | store |
| Backup-1 | Active data | Active data | In backup | In backup |
| | store | store | | |
| Backup-2 | Active data | In backup | In backup | In backup |
| | store | | | |

TABLE 5
Use over time of the hard disk drive 1000 when disk-mode 2502
dictates backup-1, or one internal backup as shown in Table 3.

| | Time | | |
|---|---|---|---|
| | | | After restoring |
| | Before backup | After Backup | from backup |
| First disk | Active data | Active data | Active data surface |
| surface 180 | surface 1 | surface 1 | at time of backup |
| | | after backup | |
| Second disk | In backup | Inactive data = | Inactive data = |
| surface 182 | surface 1 | active data surface | active data surface |
| | | 1 at time of backup | 1 at time of backup |
| Third disk | Active data | Active data surface | Active data surface |
| surface 184 | surface 2 | 2 after backup | 2 at time of backup |
| Fourth disk | In backup | Inactive data = | Inactive data = |
| surface 186 | surface 2 | active data surface | active data surface |
| | | 2 at time of backup | 2 at time of backup |

TABLE 6
Use over time of the hard disk drive 1000 when the disk-mode 2502 dictates backup-2, or three internal backups.

| | Time | | | | | | |
|---|---|---|---|---|---|---|---|
| | | | | | Restoring active | Restoring active | Restoring active |
| | Before | After backup 1, | After backup 2, | After backup 3, | data from most | data from second | data from third |
| | backup | before backup 2 | before backup 3 | before backup 4 | recent backup | most recent backup | most recent backup |
| First disk | Active data | Active data | Active data | Active data | Copy of active | Copy of active | Copy of active |
| surface 180 | surface 1 | surface 1 | surface 1 | surface 1 | data surface | data surface | data surface 1 |
| | | | | | 1 at backup-3 | 1 at backup-2 | at backup-1 time |
| | | | | | time | time | |
| Second disk | In backup | Copy of active | Copy of active | Copy of active | Copy of active | Copy of active | Copy of active |
| surface 182 | surface 1 | data surface 1 | data surface | data surface | data surface | data surface | data surface 1 |
| | | at backup-1 | 1 at backup-1 | 1 at backup-1 | 1 at backup-1 | 1 at backup-1 | at backup-1 time |
| | | time | time | time | time | time | |
| Third disk | In backup | In backup | Copy of active | Copy of active | Copy of active | Copy of active | Copy of active |
| surface 184 | surface 2 | surface 2 | data surface | data surface | data surface | data surface | data surface 1 |
| | | | 1 at backup-2 | 1 at backup-2 | 1 at backup-2 | 1 at backup-2 | at backup-2 time |
| | | | time | time | time | time | |
| Fourth disk | In backup | In backup | In backup surface 3 | Copy of active | Copy of active | Copy of active | Copy of active |
| surface 186 | surface 3 | surface 3 | | data surface | data surface | data surface | data surface 1 |
| | | | | 1 at backup-3 | 1 at backup-3 | 1 at backup-3 | at backup-3 time |
| | | | | time | time | time | |

An embodiment of a hard disk drive 1000 containing eight disk surfaces and the configurations preferably supported by the disk-mode 2502 is shown in Table 7. There are several alternative configurations, which may be preferred in certain embodiments of the invention. Backing up data may proceed similarly as previously shown.

TABLE 7
One embodiment of the hard disk drive 1000 containing
eight disk surfaces and the configurations preferably
supported by the disk-mode 2502 of FIG. 1A.

| | Disk-mode 2502 | | |
|---|---|---|---|
| | Backup-1 | Backup-2 | Backup-3 |
| First disk | Active disk | Active disk | Active disk |
| surface 180 | surface 1 | surface 1 | surface 1 |
| Second disk | Inactive backup | Inactive backup | Inactive backup |
| surface 182 | surface 1 | surface 1 | surface |
| Third disk | Active disk | Inactive 2^{nd} | Inactive 2^{nd} |
| surface 184 | surface 2 | backup | backup surface |
| | | surface 1 | |
| Fourth disk | Inactive backup | Inactive 3^{rd} | Inactive 3^{rd} |
| surface 186 | surface 2 | backup | backup surface |
| | | surface 1 | |
| Fifth disk | Active disk | Active disk | Inactive 4^{th} |
| surface 188 | surface 3 | surface 2 | backup surface |
| Sixth disk | Inactive backup | Inactive backup | Inactive 5^{th} |
| surface 190 | surface 3 | surface 2 | backup surface |
| Seventh disk | Active disk | Inactive 2^{nd} | Inactive 6^{th} |
| surface 192 | surface 4 | backup | backup surface |
| | | surface 2 | |
| Eighth disk | Inactive backup | Inactive 3^{rd} | Inactive 7^{th} |
| surface 194 | surface 4 | backup | backup surface |
| | | surface 2 | |

The hard disk drive 1000 of FIG. 1A may include more than a first disk 30, which provides more than the first disk surface 180 and the second disk surface 182, as shown in FIG. 1B. The hard disk drive may preferably include a second disk 32, which may provide a third disk surface 184 and a fourth disk surface 186. The hard disk drive may preferably include a third disk 34, which may provide a fifth disk surface 188 and a sixth disk surface 190. The hard disk drive may preferably include a fourth disk 36, which may provide a seventh disk surface 192 and an eighth disk surface 194. The hard disk drive may include more than four disks. While this discussion will restrict itself to hard disk drives including up to four disks, aspects of the invention may include more than four disks.

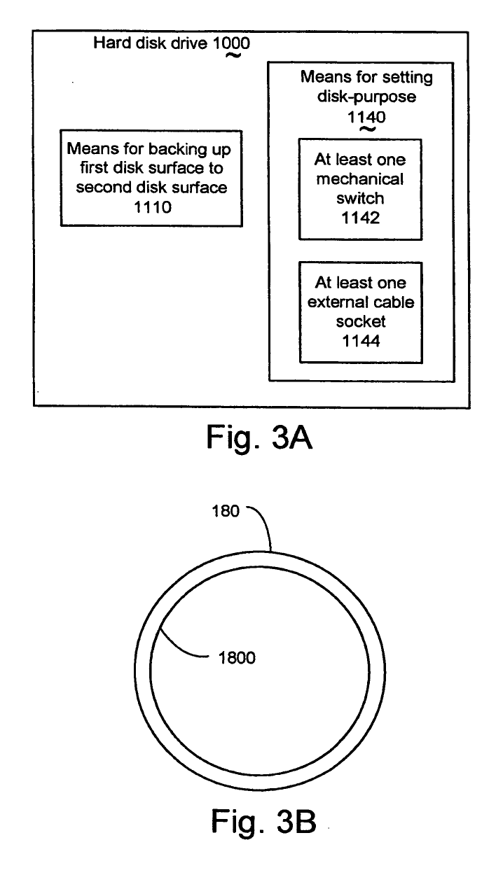

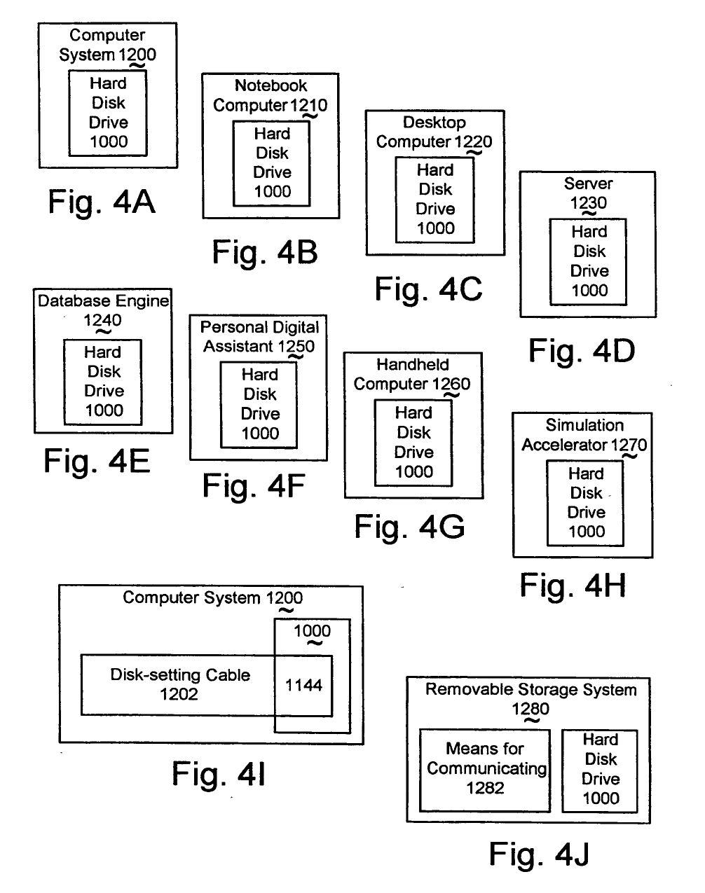

FIG. 3A shows an alternative schematic view of the hard disk drive 1000 of FIGS. 1A and 1B, including the following. A means for backup 1110 of the first disk surface 180 to the second disk surface 182 when the disk-command 2500 is the backup-purpose 2512. The means of FIG. 4B may include at least one of following. A finite state machine, a computer 2100, a program step residing in the memory 2120 accessibly coupled 2122 with the computer 2100, and a program system 3000 including at least one of the program steps. The hard disk drive 1000 is further shown including a means for setting 1140 the disk-command 2500. The means for setting 1140 may include, but is not limited to, at least one mechanical switch 1142, and/or at least one external cable socket 1144.

The invention includes a computer system 1200, which includes the invention's hard disk drive 1000. FIG. 4A to FIG. 4H show some examples of computer systems including the hard disk drive. FIG. 4A shows the computer system including the hard disk drive. FIG. 4B shows a notebook computer 1210 including the hard disk drive. FIG. 4C shows a desktop computer 1220 including the hard disk drive. FIG. 4D shows a server 1230 including the hard disk drive. FIG. 4E shows a database engine 1240 including the hard disk drive. FIG. 4F shows a personal digital assistant 1250 including the hard disk drive. FIG. 4G shows a handheld computer 1260 including the hard disk drive. FIG. 4H shows a simulation accelerator 1270 including the hard disk drive. The computer system 1200 may include more than one of the hard disk drive.

FIG. 4I shows the computer system 1200 of FIG. 4A further including a disk-setting cable 1202 coupled to the external cable socket 1144 of FIG. 3B. The disk-setting cable is preferably used to, at least partly, set the disk-command 2500. Further, the disk-setting cable may be used to set the disk-command to at least one of the following, the backup-purpose 2512, and the restore-purpose 2519.

The invention also includes a removable storage system 1280, comprising at least one hard disk drive 1000, as shown in FIG. 4J. The removable storage system may further, preferably, include at least one means for communicating 1282 with a computer system via a physical transport. The physical transport may include at least one of a wireless physical transport and/or at least one wireline physical transport. The wireless physical transport may include support for a Bluetooth interface. The wireline physical transport includes support for at least one of the following: a PCMCIA (Personal Computer Memory Card International Association) interface and a USB (Universal Serial Buss) interface.

In certain embodiments of the invention, the embedded printed circuit board 2000 of FIG. 1A may not include micro-actuator interfaces 2010 and the first head gimbal assembly 60 may not include the micro-actuator assembly 200. When present, the micro-actuator assembly 200 may use at least one piezoelectric device and/or at least one electrostatic device.

The memory 2120 of FIG. 1A may include at least one non-volatile memory location. This memory may include at least one volatile memory location. A memory location is non-volatile when its contents are not altered when there is no power applied to the memory. A memory location is volatile when its contents may be altered when there is no power.

In FIG. 1B, the first actuator arm 50 couples to the first head gimbal assembly 60. The first head gimbal assembly includes the first slider 100, shown in FIGS. 1A and 1B, which includes the read-write head 10. This read-write head accesses the first disk surface 180.

Also in FIG. 1B, the second actuator arm 52 couples with the second head gimbal assembly 62 and also couples with the third head gimbal assembly 64. The second head gimbal assembly includes the second slider 102, which includes the second read-write head 12. The second read-write head accesses the second disk surface 182. The third head gimbal assembly includes the third slider 104, which includes the third read-write head 14. The third read-write head accesses the third disk surface 184.

Also in FIG. 1B, the third actuator arm 54 couples with the fourth head gimbal assembly 66 and also couples with the fifth head gimbal assembly 68. The fourth head gimbal assembly includes the fourth slider 106, which includes the fourth read-write head 16. The fourth read-write head accesses the fourth disk surface 186. The fifth head gimbal assembly includes the fifth slider 108, which includes the fifth read-write head 18. The fifth read-write head accesses the fifth disk surface 188.

Also in FIG. 1B, the fourth actuator arm 54 couples with the sixth head gimbal assembly 70 and also couples with the seventh head gimbal assembly 72. The sixth head gimbal assembly includes the sixth slider 110, which includes the sixth read-write head 20. The sixth read-write head accesses the sixth disk surface 190. The seventh head gimbal assembly includes the seventh slider 112, which includes the seventh read-write head 22. The seventh read-write head accesses the seventh disk surface 192.

Also in FIG. 1B, the fifth actuator arm 58 couples with the eighth head gimbal assembly 74. The eighth head gimbal assembly includes the eighth slider 114, which includes the eighth read-write head 24. The eighth read-write head accesses the eighth disk surface 194.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method to backup a first disk surface to a second disk surface, both included in a hard disk drive, comprising the step of:
copying said first disk surface to said second disk surface.

2. The method of claim 1, wherein the step copying said first disk surface to said second disk surface, further comprises, for each of said logical track locations on said first disk surface, the steps of:
copying a track at said logical track location from said first disk surface to said logical track on said second disk surface.

3. The method of claim 1, wherein the step copying said first disk surface to said second disk surface further comprises the step of:
copying said first disk surface to said second disk surface, when said disk-command is said backup-purpose.

4. The method of claim 3, further comprising the step of: copying said second disk surface to said first disk surface, when said disk-command is a restore-purpose.

5. Said hard disk drive of claim 1, comprising: means for backup of said first disk surface to said second disk surface when said disk-command is said backup-purpose.

6. Said hard disk drive of claim 5, wherein said means includes at least one of: a finite state machine, a computer, a program step residing in a memory accessibly coupled with said computer, and a program system including at least one of said program steps;
wherein said computer includes at least one instruction processor and at least one data processor; wherein each said data processors is directed by at least one of said instruction processors.

7. Said hard disk drive of claim 1, comprising: a computer accessibly coupled with a memory and directed by a program system including program steps residing in said memory;
wherein said program system comprises the program steps of:
copying of said first disk surface to said second disk surface when said disk-command is said backup-purpose.

8. Said hard disk drive of claim 7, wherein said memory includes at least one non-volatile memory location.

9. The hard disk drive of claim 1, further comprising a means for setting said disk-command.

10. The hard disk drive of claim 9, wherein said means for setting said disk-command includes at least one mechanical switch.

11. The hard disk drive of claim 9, wherein said means for setting said disk-command includes at least one external cable socket.

12. A computer system including at least one of said hard disk drives of claim 1.

13. The computer system of claim 12, wherein said computer system includes at least one of a notebook computer, a desktop computer, a server, a database engine, a personal digital assistant, a handheld computer, and a simulation accelerator.

14. The computer system of claim 12, further including a disk-setting cable coupled to an external cable socket included in said hard disk drive; wherein said disk-setting cable is used to at least partly set said disk-command.

15. The computer system of claim 14, wherein said disk-setting cable is used to set said disk-command to at least said backup-purpose.

16. A removable storage system including at least one of said hard disk drives of claim 1.

17. Said removable storage system of claim 16, further including at least one means for communicating with a computing system via a physical transport.

18. Said removable storage system, wherein said physical transport includes at least one of a wireless physical transport and a wireline physical transport.

19. Said removable storage system of claim 18, wherein said wireless physical transport includes support for a Bluetooth interface.

20. Said removable storage system of claim 18, wherein said wireless physical transport includes support for at least one of a PCMCIA interface and a Universal Serial Buss (USB) interface.

21. A method of making said hard disk drive of claim 7, comprising the steps of:
installing said program system into said memory.

22. The hard disk drive as the product of the process of claim 21.
